(19) United States
(12) Patent Application Publication
(10) Pub. No.: US 2013/0092099 A1
(43) Pub. Date: Apr. 18, 2013

(54) SYSTEMS AND METHODS FOR ANIMAL CONTAINMENT AND PREMISES MONITORING

(71) Applicant: Titan Pet Products, Inc., Raleigh, NC (US)

(72) Inventors: Jason A. Hardi, Raleigh, NC (US); Fredrik Daapan Andersen, Miami, FL (US)

(73) Assignee: TITAN PET PRODUCTS, INC., Raleigh, NC (US)

(21) Appl. No.: 13/653,402

(22) Filed: Oct. 16, 2012

Related U.S. Application Data
(60) Provisional application No. 61/548,682, filed on Oct. 18, 2011.

(51) Int. Cl. A01K 15/04

(52) U.S. Cl. 119/721

(57) ABSTRACT

Devices and methods for monitoring operation of components of animal containment systems, and for notifying responsible parties of faults, status, or changes of status of such systems are provided. A device for monitoring operation of an animal containment boundary defining apparatus detects presence, absence, magnitude, and/or change in magnitude of at least one electrical signal in a boundary defining wire, and generates a responsive alarm signal. Devices for affecting operation of a premises security system with a motion detector involve use of a secondary detector to detect presence, absence, proximity, status, or movement of an animal tag or collar. A secondary animal tag or collar with detection and communication capability may be used to detect operation status or failure of a primary animal tag or collar arranged to cooperate with an animal containment boundary defining element (e.g., buried wire).

### STATEMENT OF RELATED APPLICATION(S)

This application claims priority to U.S. Provisional Patent Application No. 61/548,682 filed on Oct. 18, 2011. The entire contents of the foregoing provisional application are hereby incorporated by reference herein, for all purposes.

### TECHNICAL FIELD

The present invention relates to systems and methods for containing, monitoring, training, and interacting with animals (including pets) and for promoting premises security.

### BACKGROUND

Companion animals or pets provide numerous benefits to their caregivers. Caring for a companion animal provides purpose and fulfillment, and lessens feelings of loneliness and depression in people of all age groups. Various animal and animal behaviors, however, can present challenges and frustrations to animal owners. It can be difficult and expensive to train or condition animals to refrain from unwelcome behaviors, including wandering into off-limits areas of a home or area, barking uncontrollably, and escaping outside beyond the confines of a yard. It can also be devastating to learn of the escape and possible loss of an animal.

As an alternative to conventional fencing, electronic animal control systems utilizing radio frequency collars or tags attached to an animal to limit the movement of the animal to a predetermined area of confinement are known (e.g., as disclosed in U.S. Pat. Nos. 3,753,421, 5,207,179, and 5,967,094. The predetermined area is defined by the physical arrangement of at least one buried (subterranean) wire that serves as a signal transmission antenna. A buried wire is operatively coupled to a signal transmitter and transmits an electromagnetic signal. When an animal collar or tag including a radio frequency receiver is in proximity to the buried wire, the receiver detects the electromagnetic signal and delivers a warning stimulus (e.g., audible tone) or correction stimulus (e.g., vibration or electric shock). The effect of repeated stimulus teaches the animal (e.g., a dog) wearing the collar or tag to avoid a limit area, thereby confining the animal without requiring use of above-ground fences or barriers. Such systems are commonly employed, with well over one million installations believed to be completed to date in the United States.

One drawback of the foregoing animal control systems utilizing subterranean wires is that it may be difficult for a user to timely detect when the system is not operational (e.g., due to a broken subterranean wire, failure of power supplied to the subterranean wire, depletion of a battery or other failure of an electronic collar or tag, or the like). It would be desirable to rapidly detect and notify an owner of a failure of one or more components animal confinement system. It would further be desirable to enable retrofit of existing systems to provide such functionality.

Another challenge posed by animals involves triggering of false alarms of premises security systems. For example, it may be desirable to utilize motion detectors (e.g., microwave, ultrasonic, or infrared-based signal transmitters and associated signal detectors arranged to receive reflected signals) in premises security systems, but such detectors may be unable to discriminate between animals (e.g., pets) rightfully present in specified premises versus intruders not authorized to be so present. In many instances where premises security systems are to be installed in premises where animals are likely to be present, glass breakage sensors are substituted for motion detectors in order to reduce likelihood of false alarms; however, it may be easier for an intruder to avoid triggering a glass breakage sensor than to avoid triggering a motion detector. Accordingly, it would be desirable to avoid triggering by animals of false alarms through operation of motion detectors associated with premises security systems.

In consequence, the art continues to seek improvements in animal containment and premises monitoring systems.

### SUMMARY

The present invention relates in various aspects to devices and methods for monitoring operation of at least certain components of animal containment systems, and for notifying responsible parties (e.g., animal owners) of faults, status, or changes of status of such systems. The present invention relates in various other aspects to systems and methods for reducing false alarms of premises security systems by augmenting motion detection with animal proximity sensing utilizing sensors arranged to communicate with electronic animal collars or tags.

In one aspect, the invention relates to a device for monitoring operation of an animal containment boundary defining apparatus that includes at least one boundary signal transmitting wire, the device comprising: a power input element connectable to an electric power source; at least one sensing element arranged to detect at least one of presence, absence, magnitude, and change in magnitude of at least one electrical signal in the at least one boundary signal transmitting wire; and an alarm signal generating element arranged to generate at least one primary alarm signal upon detection by the at least one sensing element of at least one of presence, absence, magnitude, and change in magnitude of at least one electrical signal in the at least one boundary signal transmitting wire.

In another aspect, the invention relates to a method of affecting operation of a premises security system including a motion detector, the method utilizing an animal collar or tag that includes at least one of a mobile radio frequency transmitter and a mobile radio frequency receiver, the method comprising: sensing a condition indicative of any of (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generating an animal status output signal indicative of said sensed condition; and utilizing the animal status output signal to affect whether a motion detector output signal should be used to trigger a premises security system alarm signal.

In another aspect, the invention relates to a motion detector for a premises security system, the motion detector comprising: a primary signal transmitter arranged to transmit a primary wireless signal; a primary signal detector arranged to receive a reflected portion of the primary wireless signal and responsively generate a primary signal detector output signal; a secondary signal detector arranged to communicate with a mobile signal transmitter of an animal collar or tag, and arranged to sense a condition indicative of any of (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generate an animal status output signal indicative of said sensed condition; and a signal processing element arranged to utilize the primary signal detector output signal and the animal status output signal, and responsively generate a motion detector output signal.

In still another aspect, the invention relates to a premises security system comprising: a motion detector including (a) a primary signal transmitter arranged to transmit a primary wireless signal, and (b) a primary signal detector arranged to receive a reflected portion of the primary wireless signal and responsively generate a motion detector output signal; a secondary signal detector arranged to communicate with a mobile signal transmitter of an animal collar or tag, and arranged to sense a condition indicative of any of (i) presence of the animal collar or tag proximate to the motion detector, (ii) absence of the animal collar or tag proximate to the motion detector, (iii) proximity of the animal collar or tag relative to the motion detector, and responsively generate an animal status output signal indicative of said sensed condition, (iv) stasis of the animal collar or tag, and (v) movement of the animal collar or tag; and a signal processing element arranged to utilize the animal status output signal in determining any of (A) whether the motion detector output signal should be transmitted to a control element of the premises security system and (B) whether the premises security system should output a premises security system alarm signal.

In another aspect, the invention relates to an apparatus for affecting operation of a premises security system that comprises a motion detector including (a) a primary signal transmitter arranged to transmit a primary wireless signal, and (b) a primary signal detector arranged to receive a reflected portion of the primary wireless signal and responsively generate a motion detector output signal, the apparatus comprising: a secondary signal detector arranged to communicate with a mobile signal transmitter of an animal collar or tag, and arranged to sense a condition indicative of any of (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generate an animal status output signal indicative of said sensed condition; and a signal processing element arranged to utilize the animal status output signal in determining any of (A) whether the motion detector output signal should be transmitted to a control element of the premises security system and (B) whether the premises security system should output a premises security system alarm signal.

In another aspect, the invention relates to a secondary electronic animal tag or collar arranged to be worn by an animal and interoperable with (i) a primary electronic tag or collar worn by the animal and (ii) at least one radio frequency transmit/receive station remotely located relative to the animal, wherein the primary tag or collar comprises a primary battery, a warning signal generating element arranged to generate a user-perceptible or pet-perceptible warning signal, and a primary receiver arranged to receive a premises defining signal generated by a premises defining signal generating element, and wherein the secondary electronic animal tag or collar comprises: a secondary battery; at least one signal transmitter arranged to receive power from the secondary battery and to generate (a) a wireless signal arranged to be received by the primary receiver, and (b) a wireless signal arranged to be received by the at least one radio frequency transmit/receive station; and a warning signal receiver arranged to receive the user-perceptible or pet-perceptible warning signal; wherein the secondary electronic animal tag or collar is arranged to (a) generate a wireless signal arranged to be received by the primary receiver to trigger generation by the warning signal generating element of the user-perceptible or pet-perceptible warning signal, (b) detect at least one of presence, absence, and strength of the user-perceptible or pet-perceptible warning signal using the warning signal receiver, and (c) transmit a wireless signal to the at least one radio frequency transmit/receive station based upon at least one of presence, absence, and strength of the user-perceptible or pet-perceptible warning signal.

In a further aspect, any one or more features of the foregoing aspects or features otherwise disclosed herein may be combined for additional advantage.

Other aspects, features and embodiments of the invention will be more fully apparent from the ensuing disclosure and appended claims.

### BRIEF DESCRIPTION OF THE DRAWINGS

FIG. 1 is a schematic interconnect diagram showing connections between various components of a system for monitoring operation of an animal containment boundary defining apparatus that includes first and second boundary signal transmitting wires.

FIG. 2 is a schematic interconnect diagram showing connections between various elements of a monitoring device for monitoring boundary signal transmitting wires of an animal containment boundary defining apparatus.

FIG. 3 is a schematic diagram depicting components of an animal containment and monitoring system including a primary electronic animal tag or collar arranged to interact with at least one boundary signal transmitting wire, a secondary electronic animal tag or collar arranged to permit monitoring of the primary electronic animal tag or collar, and at least one radio frequency transmit/receive (RFTR) station in communication with the secondary electronic animal tag or collar and other components including a communication network.

FIG. 4 is a schematic interconnect diagram showing connections between various elements of a radio frequency transmit/receive (RFTR) station such as illustrated in FIG. 3.

FIG. 5A is a schematic interconnect diagram of various components of a premises alarm system including a motion detector having a primary transmitter, a primary receiver, and a secondary receiver arranged to communicate with an electronic animal collar or tag, with the motion detector further including a signal processor arranged to receive signals from the primary and secondary receivers.

FIG. 5B is a schematic interconnect diagram of various components of a premises alarm system including (i) a motion detector having a primary transmitter and a primary receiver, and (ii) a secondary receiver arranged to communicate with an electronic animal collar or tag and a signal processor, with the signal processor being arranged to receive signals from the primary and secondary receivers.

FIG. 5C is a is a schematic interconnect diagram of various components of a premises alarm system including (i) a motion detector having a primary transmitter and a primary receiver, and (ii) a secondary receiver arranged to communicate with an electronic animal collar or tag, wherein signals from the motion detector and the secondary receiver are provided to a premises alarm controller.

### DETAILED DESCRIPTION

The present invention relates in various aspects to systems and methods for containing, monitoring, training, and interacting with animals and for promoting premises security. Various embodiments utilize electronic animal tags (optionally integrated with or substituted by a collar) and related communication devices. Although animal tags may be mentioned in the following disclosure, it is to be appreciated that such tags may be interpreted as encompassing tags and/or collars.

In certain embodiments, an electronic animal tag as described herein is arranged for wearing by an animal and may include one or more of the following elements: at least one wireless receiver (e.g., a mobile RF receiver), at least one wireless transmitter (e.g., a mobile RF transmitter), a microprocessor, a charge storage element, at least one stimulus element for applying stimulus to an animal, at least one sensor, and may include additional elements. A mobile RF receiver and a mobile RF transmitter may be combined in a mobile RF transceiver. In one embodiment, a RF receiver and a RF transmitter operate at 433 MHz. Additional and/or other frequency ranges may be used.

In certain embodiments, an electronic animal tag is arranged to communicate with at least one radio frequency transmit/receive (RFTR) station (or multiple RFTR stations). A RFTR station preferably includes a RF transmitter and a RF receiver (optionally integrated within a RF transceiver) arranged to communicate wirelessly in two-way fashion with one or more electronic animal tags as described herein. Two, three, or more RFTR stations may be provided in a single region in certain embodiments. When multiple RFTR stations are provided, such stations are preferably arranged for communication with one another, preferably on a wireless (e.g., RF) basis, but optionally by wired communication, such as (but not limited to) power line communication when such RFTR stations are coupled to an interconnected power supply system (such as an electrical system within a home or other building), or any other conventional type of wired communication with or without an appurtenant communication network. Wired or wireless communications between RFTR stations may utilize any suitable protocol. In one embodiment, Wireless Application Protocol communications are utilized. In one embodiment, Zwave wireless communication protocol is used. In one embodiment, each RFTR station includes a static Internet protocol (IP) address to facilitate access of such stations via a distributed electronic communication network.

In one embodiment, multiple RFTR stations may embody similar or substantially identical functionality and engage in peer-to-peer communications. In another embodiment, one or more master RFTR stations may be utilized in conjunction with one or more satellite RFTR stations, with master and satellite RFTR stations embodying different combinations of features. For example, a master RFTR station may include a network communication element arranged to communicate with a network communication terminal via an intervening communication network. Communications between RFTR stations may be initiated, controlled, and/or regulated by a master RFTR station, such as by polling one or more satellite RFTR stations.

In one embodiment, at least one satellite RFTR station may function to relay signals between a distant RFTR satellite station and a master RFTR station, wherein the distant RFTR satellite station would otherwise be out of reliable signal reception range of the master RFTR station.

When multiple RFTR stations are employed, such stations are preferably spatially segregated from one another within a structure and/or area. In various embodiments, spatially segregated RFTR stations are disposed preferably at least about 5 meters apart, more preferably at least about 10 meters apart, more preferably at least about 15 meters apart, or at least about 20 meters apart. Utilization of multiple spatially segregated RFTR stations arranged to simultaneously communicate with one or more electronic animal collars or tags is advantageous to enable wireless detection and monitoring of position of the one or more electronic animal tags or collars. Position of an animal collar or tag may be determined by simultaneous communication with multiple RFTR stations, for example, by assessing instantaneous signal strength relative to the RFTR stations, by ascertaining delay in reception of a timed signal emitted by the RFTR stations, or by other triangulation methods well-known to a person or ordinary skill in the art. Multiple RFTR stations preferably provide a mesh of overlapping signal coverage between the RFTR stations and at least one electronic animal tag or collar spanning one or more desired animal containment and/or monitoring areas, which may include one or more containment zones disposed inside and or outside of a building.

Using multiple RFTR stations, one or more physical zones or boundaries within reception range of the RFTR stations may be wirelessly defined by a user, and the RFTR stations may wirelessly detect the presence or absence of at least one animal collar or tag relative to one or more user-defined zones or boundaries. A RF communication device may be placed at a first position in or along a desired physical zone or boundary, and a user may generate a marking signal indicative of such position using the RF communication device. A RF communication device useful for generating such a marking signal may include, for example, any of an electronic animal tag or collar (e.g., by user manipulation of an input element associated with the tag or collar), a handheld remote controller adapted for RF wireless communication with said animal collar or tag, a personal computer, portable phone, or personal data assistant (PDA) device. In one embodiment, a first marking signal is generated with a RF communication device positioned at a first location in or along a first user-defined physical zone or boundary, and a second marking signal is generated using the RF communication device positioned at a second location in or along the first user-defined physical zone or boundary. Additional marking signals (e.g., third, fourth, fifth, and so on) may be generated with the marking device disposed at different locations to bound multiple sides of a physical (e.g., enclosed) zone. In one embodiment, an additional (e.g., third) marking signal may be generated using the RF communication device as indicative of a location outside a first user-defined physical zone or boundary. Yet another (e.g., fourth) marking signal may be generated using the RF communication device as indicative of the location within a first user-defined physical zone or boundary. Multiple user-defined physical zones or boundaries, whether within or outside of a building (such as a house) may be wirelessly established and easily reconfigured, without requiring buried signal cables commonly associated with conventional outdoor animal containment systems. One or more actions may be selected to be automatically initiated upon wireless detection of presence or absence of said animal collar or tag relative to the at least one user-defined physical zone or boundary.

In response to generation of the marking signal, information indicative of sensed properties of at least one RF signal communicated between the RF communication device and multiple RFTR stations is stored in a memory element preferably associated with at least one RFTR station (or optionally stored in a memory element associated with an electronic tag or collar). Such a memory element preferably comprises nonvolatile memory. Sensed properties may include, for example, at least one of (a) strength of a RF signal transmitted by the RF communication device and received by a plurality of RFTR stations, and (b) strength of RF signals transmitted by the RFTR stations and received by the RF communication device. Following storage in memory of sensed properties indicative of at least one user-defined zone or boundary, properties of at least one RF signal communicated between an electronic animal collar or tag and multiple RFTR stations are sensed on an ongoing basis, and instantaneously sensed properties are compared with one or more stored properties to ascertain location of an electronic animal collar or tag relative to the at least one user-defined zone or boundary.

In addition to position, other attributes of an animal wearing an electronic animal tag or collar may be monitored via two-way communication between such tag or collar and at least one RFTR station. An electronic animal tag or collar may include one or more sensors of various types adapted to sense conditions experienced by the tag and/or physiological conditions of an animal wearing the electronic tag. Multiple sensors may be provided. In various embodiments, one or more sensors associated with an electronic tag or collar may be arranged to sense any one or more of temperature, pressure, moisture, motion, stasis, acceleration, noise, pulse/heartbeat, and the like. Signals from such sensors may be used to trigger alarms and/or implement other actions. User-perceptible alarm outputs may be generated by an electronic tag or collar, by at least one RFTR station in communication with the electronic tag or collar, a RFTR remote controller station, a local communication device, and/or a network communication terminal in direct or indirect communication with at least one RFTR station. Messages of various forms may be communicated to a network communication terminal, such as audible tones, prerecorded messages, email messages, SMS (text) messages, facsimile transmissions, and so on. As one example of a condition that may trigger an alarm, sensing of excess temperature by at least one sensor associated with an electronic tag or collar may indicate that an animal is located in a dangerously hot environment (e.g., a hot car interior). In another example, sensing of moisture by at least one sensor associated with an electronic tag or collar may indicate that an animal has fallen into a pool or lake. In another example, sensing of movement and/or acceleration by at least one sensor associated with an electronic tag or collar may indicate that the animal is awake, whereas lack of motion and/or acceleration for a specified period may indicate that the animal is asleep. Sensing of noise with at least one sensor associated with electronic tag or collar may be used to augment signals received from a tag- or collar-mounted piezoelectric element (useful for both bark detection and administering vibration) to discriminate between barks and other sounds (e.g., whines, growls) emitted by an animal wearing an electronic tag or collar, and/or to confirm whether a bark or other sound is emanating from the animal wearing the electronic tag or collar. Actions such as triggering of alarms, triggering of (e.g., user) notification events, activation of lights, depowering of the tag or collar, activation of at least one camera or microphone, logging data (or logging data at higher frequency), and the like may be implemented in response to receipt of signals from the sensors associated with an electronic tag or collar.

Based on presence (or absence) of an electronic animal tag or collar in a user-defined zone or boundary, and/or upon receipt of a signal indicative of a condition sensed by at least one sensor associated with the electronic animal tag or collar, various actions may be automatically initiated. In one embodiment, corrective action may be administered to the animal by the electronic animal tag or collar. Examples of such corrective action include administration of vibration and/or electric shock to deter or prevent unwanted animal behavior such as, but not limited to, movement into or out of a user-defined zone or boundary, barking, whining, jumping, or the like. The electronic animal tag or collar may be placed into an alarm condition, such as by triggering any one or more of the following functions associated with the tag or collar: activation of flashing lights; activation of audible alarm signals or messages; activation of a RF beacon differing in strength, frequency, and/or character from RF signals typically emitted by the tag or collar; and activation of a global positioning system (GPS) receiver associated with the electronic tag or collar. In one embodiment, an alarm signal generator (whether associated with an animal tag or collar, at least one RFTR station, or at least one device in communication therewith) generates an alarm signal responsive to receipt of a RF signal indicative of at least one of: condition of the animal, behavior of the animal, proximity of the animal to any one or more RFTR stations of the plurality of RFTR stations, and lack of communication between the animal collar or tag and any one or more RFTR stations of the plurality of RFTR station. In one embodiment, a network communication element is arranged to automatically communicate with at least one network communication terminal responsive to receipt or generation of a RF signal indicative of at least one of: condition of an animal with which the animal collar or tag is associated, behavior of the animal, proximity of the animal to any one or more RFTR stations of the plurality of RFTR stations, and lack of communication (loss of signal) between the animal collar or tag and any one or more RFTR stations of the plurality of RFTR station. The at least one network communication terminal may include one or more communication devices (e.g., phone, pager, PDA, personal computer or the like) associated with one or more users, home alarm monitoring companies, animal shelters, animal tracking organizations, law enforcement agencies, and designated third parties. A network communication terminal may further include a RFTR remote controller station as described herein. Various actions triggered by an electronic animal tag or collar, and/or at least one RFTR station, may be configured by a user. In one embodiment, a graphical user interface associated with a computing device is used to select and/or configure such actions.

In order to reduce incidence of false alarms, one or more delays may be predefined or programmed to elapse prior to triggering an alarm. For example, if any electronic animal tag should go out of communication range with one or more RFTR stations for a threshold period of time, such event may indicate that an animal wearing the tag has escaped a specified area (e.g., a home or yard) on a non-momentary basis, and at least one RFTR station may activate one or more alarms, initiate automatic notification procedures, and/or initiate tracking procedures.

An animal containment and monitoring system including at least one RFTR station and an electronic animal tag or collar as described herein may be subject to multiple different operating modes to regulate or affect behavior of an animal wearing such a tag or collar. In one embodiment, at least one operating mode causes the animal collar or tag to administer vibration and at least one other operating mode causes the animal collar or tag to administer electric shock. Such adjustment permits a user to select an action appropriate to a specific animal to deter unwanted behavior.

In one embodiment, a plurality of operating modes includes (i) at least one “anti-bark” mode to cause the animal collar or tag to administer any of a warning signal and a correction signal upon detection of sound or vibration emitted by an animal (e.g., a bark) wearing the animal collar or tag, and (ii) at least one other “permissive bark” mode to cause the animal collar or tag to neither administer a warning signal nor administer a correction signal upon detection of sound or vibration emitted by an animal wearing the animal collar or tag.

In one embodiment, a plurality of operating modes includes at least one mode in which, upon detection of sound or vibration emitted by the animal wearing the animal collar or tag prior to entry of the animal collar or tag into a “no-entry” or “response” zone or boundary (as user-defined via electronic marking, described herein), the animal collar or tag is caused to temporarily suspend administration of a warning signal or a correction signal after entry of the animal collar or tag into the response zone. Such mode may be useful so as not to deter an animal dog from barking upon hearing a suspicious noise suggestive of an intruder, or confronting an intruder near a point of entry. For example, a response zone may be defined by a user near a door or other point of entry into a home. A dog located outside the response zone may hear a noise suggestive of an intruder seeking forced entry. If the dog should start barking before entering the response zone, then administration of a warning signal or a correction signal to the dog may be suspended while the dog is in the response zone (or for a specified period after entry into or exit from the response zone). In one embodiment, a suspension of warning and/or correction signal may be restricted only to barking, to maintain containment functionality so as to prevent escape of the animal if a door or window is opened. The foregoing operating mode (temporary suspension of warning or correction if an animal barks before entering a response zone) may be automatically terminated upon a specified condition, such as expiration of time, cessation of barking for a specified time, and/or absence from the response zone for a specified time. The foregoing operating mode may be desirably implemented at night when occupants of a home are normally sleeping, and when it may be useful for a dog to bark and/or confront an intruder. In one embodiment, an automatic input (e.g., ambient light sensor, timer, etc.) may be integrated or operatively coupled to a RFTR station, and the RFTR station may be programmed to automatically adopt the foregoing operating mode upon detection of an automatic input suggestive of a nighttime (or other) condition.

In one embodiment, a RFTR station may include the following operating modes, with associated user-perceptible output signals optionally provided by at least one indicator lamp (e.g., by combinations of lit lamp colors, flashing lamp patterns, alternating lamp color patters, and the like):

(1) Zone containment only with administration of warning signal only by animal collar or tag;

(2) Zone containment only with administration of warning signal, followed with correction signal, by animal collar or tag;

(3) Zone containment only with administration of correction signal only by animal collar or tag;

(4) Animal noise (e.g., bark) deterrence only with administration of warning signal only by animal collar or tag;

(5) Animal noise deterrence only with administration of warning signal, followed with correction signal, by animal collar or tag;

(6) Animal noise deterrence only with administration of correction signal only by animal collar or tag;

(7) Zone containment and independent noise deterrence with administration of warning signal only by animal collar or tag;

(8) Zone containment and independent noise deterrence with administration of warning signal, followed by correction signal, by animal collar or tag;

(9) Zone containment and independent noise deterrence with administration of correction signal only by animal collar or tag;

(10) Zone-dependent noise deterrence, with administration of warning signal only by animal collar or tag;

(11) Zone-dependent noise deterrence, with administration of warning signal, followed by correction signal, by animal collar or tag; and

(12) Zone-dependent noise deterrence, with administration of correction signal only.

Any of the foregoing exemplary operating modes may be omitted or supplemented with additional response, expiration, and/or sensor-dependent features, as may be readily implemented in a processor-readable instruction set stored in an animal tag or collar according to the present invention.

In one embodiment, an RFTR station includes at least one of an audio capture element, an image capture element, and a video capture element (collectively “media capture elements”). Operation of one or more media capture elements may be triggered by one or more events, such as condition of an animal with which the animal collar or tag is associated, behavior of the animal, proximity of the animal to any one or more RFTR stations of the plurality of RFTR stations, and lack of communication between the animal collar or tag and any one or more RFTR stations. Media capture elements may perform any of the following: (a) digitally store at least one of audio, images, and video captured by the at least one of an audio capture element, an image capture element, and a video capture element, and (b) transmit to a network communication terminal at least one of audio, images, and video captured by the at least one of an audio capture element, an image capture element, and a video capture element. In one embodiment, a media capture elements includes at least one camera, and the at least one camera is selectively positioned by user. In one embodiment, operation and/or positioning of a camera, modification of media capture sampling rate, and/or initiation or modification of storage of media captured by one or more media capture elements, may be triggered responsive to one or more sensed conditions. If multiple audio capture elements are provided to enable origination correction of sound to be determined, a camera may be automatically positioned in the direction from which the sound is originated, responsive to receipt of the least one audio signal. In one embodiment, a camera may be manually positioned by a user. In another embodiment, a camera may be selectively activated and/or positioned by a user manipulation of a network communication terminal (e.g., portable phone, PDA, personal computer, RFTR remote controller station, etc.) to permit a user to investigate an alarm state and/or check on an animal. A user may also acknowledge or clear an alarm state either locally (e.g., by manual interaction with a RFTR station) or remotely (e.g., using a network communication terminal). In one embodiment, a camera may include an infrared emitter and at least one infrared responsive sensor to provide night vision sensing capability that may be automatically triggered upon detection (e.g., using an ambient light sensor) of a low ambient light condition, or may be activated by a user, with conventional visible light reception provided by the camera under other ambient conditions.

Additional details regarding electronic animal tags, RFTR stations, and appurtenant devices are disclosed in U.S. Provisional Patent Application No. 61/292,073 and International Patent Application No. PCT/US10/062308 (published as International Patent Application Publication No. WO 2011/082208), which applications and publication are hereby incorporated by reference as if fully set forth herein.

In certain embodiments, an electronic animal tag or collar includes an infrared (IR) receiver arranged to receive an IR signal from at least one IR emitter arranged to define a boundary, and upon receipt of such an IR signal, to automatically undertake a predetermined or user-defined action such as administration of stimulus to the animal, generation of an alarm signal, and/or contacting one or more users or third parties. An IR emitter may be provided in a dedicated IR directional zone defining unit (as described in U.S. Patent Application Publication No. 2011/0061605A1, which is hereby incorporated by reference), or in a RFTR station as described herein.

In certain embodiments, communication and/or integration is provided between one or more RFTR stations and a premises alarm system or premises alarm sensors. In one embodiment, at least one premises alarm sensor may be integrated with or otherwise associated with a RFTR station. Such a premises alarm sensor may include at least one of: an audio capture element, an image capture element, a video capture element, a motion sensor, a contact sensor, a proximity sensor, a shock sensor, a photoelectric beam sensor, and a sensor adapted to detect the condition indicative of glass breakage. Multiple premises alarm sensors may be integrated with a single RFTR station. In one embodiment, a RFTR station having at least one premises alarm sensor further includes a network communication port arranged to permit communicate with at least one network communication terminal located remotely from the RFTR station. In one embodiment, signals obtained from one or more RFTR station-integrated premises alarm sensors may be transmitted wirelessly by the RFTR station to a RF signal receiver operatively coupled with a premises alarm system. Such an RF signal receiver may be arranged in or in communication with a premises alarm panel. In one embodiment, signals obtained from one or more RFTR station-integrated premises alarm sensors may be transmitted via powerline communication to at least one input element associated with a premises alarm system. Memory may be provided within or associated with a RFTR station to store signals received from the at least one premises monitoring element.

In one embodiment, at least one RFTR station is operatively coupled to a communications network and comprises a wireless communication hub arranged to permit wireless communication by and/or among a variety of different radio frequency communication devices, including mobile telephones, personal computers, appliance remote control systems, and premises lighting remote control systems. Such wireless communication hub may operate according to IEEE 802.xx wireless network protocols and standards. In one embodiment, a master RFTR station comprises a wireless communication hub, and multiple spatially segregated satellite RFTR stations provide signal relaying functionality for wireless communications. Through use of multiple spatially segregated RFTR stations dispersed within a facility or premises, dead spots or regions of low signal strength within a facility or region are minimized or eliminated altogether.

Notification procedures may be configured by a user upon initial set-up and registration of one or more RFTR stations. A RFTR station synchronizes with any other RFTR stations in signal reception range. Password and/or firewall protection may be integrated into at least one RFTR station. A RFTR station automatically synchronizes with one or more electronic animal tags and/or premises alarm sensors in proximity upon power-up, and identifying information for each electronic tag and/or premises alarm sensor is communicated automatically to the RFTR station. An output element (e.g., lamp) of the RFTR station may provide one or more signals indicative of electronic animal tag or premises alarm sensor synchronization status, electronic tag or premises alarm sensor battery status, network communication status, and the like. Each RFTR station, and optionally each electronic animal tag or collar and one or more components of an alarm system, may include a static IP address or other network identifier. A RFTR station may automatically register itself, any synchronized RFTR stations, any synchronized electronic animal tags, and any synchronized premises alarm components via one or more websites. A user may utilize a communication device such as a personal computer, portable phone, or PDA to connect to a website providing one or more templates or form eliciting the following: (A) animal information (including animal description, animal photos, animal microchip information, and veterinary information), (B) premises information (address, special emergency instructions including user family medical conditions, locations of bedrooms within a home, location of water sources for combating fire, location of utility shutoffs, etc.) (C) user contact information and communication preferences (e.g., order of contact, format of electronic contact, priority of contact), and (D) third party contact information (e.g., home alarm monitoring company).

Any of various stationary or mobile terminals remotely located from one or more RFTR stations may be contacted via at least one communication network (e.g., Internet, telephone network, WiFi, WiMax, etc.) as part of an automatic notification procedure. Third parties susceptible to receiving notifications include, but are not limited to, one or more system users (e.g., owners of the animal to which the electronic animal tag is attached), family members or neighbors of system users, premises alarm monitoring companies, animal shelters, veterinary hospitals, law enforcement agencies, fire protection organizations, electronic animal tag manufacturers, and third party monitoring agencies. Automatic notifications may relate to animal monitoring or condition, premises monitoring or condition, or (human) user monitoring or condition. Notifications are preferably sent automatically without requiring human intervention. In one embodiment, communication is sent as a text message, SMS, and/or electronic mail to one or more users. In one embodiment, communication is sent via telephone including a recorded or machine-generated message. If animal-related monitoring triggers an alarm condition, in one embodiment, animal identifying information (e.g., including vital animal information, and preferably including one or more animal photographs) and owner contact information is automatically transmitted to animal shelters within a desired vicinity of the user within a specified time period of loss of communications between at least one RFTR station and an electronic animal tag. In one embodiment, a “lost animal” flyer or poster is automatically generated and transmitted to or otherwise accessed by a user. If premises-related monitoring triggers an alarm condition, in one embodiment, a message identifying the nature and type of the alarm, optionally including identification of alarm frequency and history of any associated alarms, may be communicated.

If an electronic animal tag should return to normal communication with at least one RFTR station, then an alarm may be cleared automatically, and communications indicating that the animal is safe may be automatically generated and distributed according to a communication procedure using contact information and preferences defined by a user. Additionally, or alternatively, an alarm may be cleared, reset, or overridden by a user via manual intervention at one or more RFTR station, or remotely using a network communication terminal, and such event may similarly trigger automated communications indicative of the alarm and/or animal status. In one embodiment, a website maintains and displays an automatically incrementing counter identifying the number of lost animals recovered by use of electronic animal tags and RFTR stations as described herein, through use of data communicated by RFTR stations to the website owner or operator.

Tracking procedures that may be initiated upon severing of contact between a RFTR station and an electronic animal tag include initiation of GPS communication with an animal tag. Under circumstances when an animal is safely located in a home or fenced yard, communication between a GPS satellite and a GPS element associated with an electronic animal tag would be unnecessary and would dramatically shorten battery life of the animal tag. By selectively activating a GPS element only when an animal has escaped a house or yard, as detected by at least one RFTR station 80, the benefits of GPS tracking may be employed only as necessary without unduly shortening battery life.

Two-way communication may be established between not only RFTR stations and each electronic animal tag (e.g., via RF communication), but also between one or more RFTR stations and remote electronic terminals (e.g., via a communication network involving wired or wireless access), and also between at least one RFTR station and one or more accessory elements, whether by wired or wireless communication. Various communication paths that may therefore be established via at least one RFTR station include, but are not limited to: (i) communications between different RFTR stations; (ii) communications between remote communication terminals and electronic animal tags, (iii) communications between remote communication terminals and premises alarm elements; (iv) communications between accessory devices and electronic animal tags, and (v) communications between remote communication terminals and accessories. Such communication paths may be used for any of remote data transfer, remote monitoring, remote control, remote updating (e.g., for software updates), remote acknowledging and clearing of alarms, and the like.

In one embodiment, data relating to information received from an electronic animal tag and/or a premises alarm system or sensor is saved and may be transmitted to a user by way of a RFTR station and communication network. Such information may be presented in any desirable format, including tables, charts, and graphs, with respect to time. Trends may be established and monitored for animal location, animal barking time, animal barking frequency, animal barking duration, animal barking intensity, animal movement, animal sleeping, animal temperature, and the like. Trends may also be established and monitored for any of various premises alarm conditions or triggered premises alarms. Ambient conditions experienced by premises and/or an electronic animal tag may also be logged and or presented. Periodic reports may be generated, and alarms may be configured for conditions that deviate from established trends, with automatic issuance of notifications to local or remote communication terminals of any suitable type.

In one embodiment, an electronic animal tag or collar may include one or more sensors of various types adapted to sense conditions experienced by the tag, physiological conditions of an animal wearing the electronic tag, and/or activity of an animal wearing the electronic tag. Signals from one or more sensors may be stored (e.g., in memory associated with a tag or collar, and/or memory associated with one or more RFTR stations, and/or memory accessible via a network in at least periodic communication with one or more RFTR stations), and trends and reports may be established. Sensed conditions deviating from established trends or patterns (e.g., normal conditions) may automatically trigger notification and/or alarms, with notifications and/or alarms being issuable by the animal tag or collar, one or more RFTR stations, and/or one or more network communication terminals in communication with one or more RFTR stations. For example, conditions indicative of an animal being awake (e.g., as may be sensed by one or more accelerometers and/or heart rate sensors associated with an electronic animal tag or collar) may be sensed and logged, and periods that the animal is aware or asleep may be compared with similar periods on previous specific days, portions of days, or other applicable periods of time. If conditions indicative of an animal being asleep or awake deviate from previously established patterns or trends, one or more alarms and/or reports may be generated. Reports may be generated and communicated to a network communication terminal whether or not an alarm condition is triggered.

Desirable accessory elements for use with one or more systems according to the present invention include both animal-related accessories (e.g., animal doors, automated animal feeding apparatuses, automated animal treat dispenser, animal toys, automated animal watering apparatuses, animal monitoring cameras) and animal-independent accessories (e.g., lamps, home appliances, HVAC systems, entertainment systems, home alarm systems, garage doors, entry gates, premises monitoring cameras, garden sprinkler systems, outdoor lighting systems, remote automotive starting systems). Operation of one or more accessory elements such as a treat dispenser and/or one or more animal toys may be configured by a user (optionally using one or more network communication devices) to automatically dispense food or treats to an animal responsive to certain animal behavior (e.g., incessant barking, elevated heart rate, detection via one or more accelerometers of repeated animal movement indicative of jumping or other agitated behavior) to distract and/or calm an animal to promote cessation of the animal behavior. In one embodiment, a food or treat dispenser and/or one or more animal toys may be remotely actuated by a user on a scheduled and/or substantially instantaneous basis. Operation of one or more accessory elements may be controlled by an animal monitoring and/or premises alarm system including one or more RFTR stations. In one embodiment, any or all programming, monitoring, control, feedback, and reporting functions may be performed with a wireless remote controller and/or network communication terminal (including but not limited to a personal computer, portable phone, personal data assistant (PDA) device, computer workstation, network server, RFTR remote controller station, and the like) operatively coupled to one or more RFTR devices, optionally via an intervening local or wide area network.

In one embodiment, accessories may be operated by electronic animal tags as worn by animals in proximity to such accessories (e.g., animal access doors). In one embodiment, accessories may be selectively operated by electronic animal tags as worn by animals, depending upon condition of one or more sensors associated with such animal tags. For example, a dog may be kept in a fenced backyard without access to a garage via an animal door under normal circumstances, but if the dog barks or whines for a specified duration, then a sensor associated with an animal tag worn by the dog may identify same and enable opening of the animal door to provide the animal with access to an indoor space and avoid potential complaints from neighbors due to animal noise. In another example, a moisture sensor associated with an electronic animal tag may sense that an outdoor animal is getting wet (indicative of ambient rain) and therefore enable opening of an animal door to provide the animal with access to an indoor space. Animal doors may include powered doors, and doors including one or more sensing elements such as a RFID reader, a magnetic reader, bar code reader, proximity sensor, or other type of code reader or signal receiver to sense a signal or code associated with an electronic animal tag or similar device associated with or wearable by an animal. In one embodiment, a system including one or more RFTR stations as disclosed herein may be operatively coupled to at least one animal door to control operation of the animal door(s). In one embodiment, an animal door may be operated with a timer that is set or configured via a network communication terminal, to cause the door to open at one or more user-defined time intervals. An animal door may also be operated on a substantially instantaneous basis using a network communication terminal.

In one embodiment, an animal treat dispenser or feeding apparatus of any desirable shape (e.g., a fire hydrant) includes a speaker, a treat release mechanism (e.g., actuated door), and a sensing element arranged to sense location of animal, conditions experienced by an electronic animal tag, and/or physiological conditions of an animal wearing an electronic tag. Any sensing element as disclosed herein may be used, including but not limited to a RFID reader, a magnetic reader, bar code reader, proximity sensor, or other type of code reader or signal receiver to sense a signal or code associated with an electronic animal tag, or sensors arranged to sense conditions indicative of temperature, pressure, moisture, motion, stasis, acceleration, noise, pulse/heartbeat, and the like. An animal treat dispenser may be operatively coupled with one or more RFTR stations as disclosed herein, whether by wired or wireless communication. An animal treat dispenser may include a wireless receiver and wireless transmitter to provide one-way or two-way communications with one or more RFTR stations, with the RFTR station enabling communication (e.g., including programming, monitoring, control, feedback, and reporting functions) between the animal treat dispenser and at least one network communication terminal as disclosed herein. In one embodiment, animal treat dispenser arranged to communicate with a network communication terminal may dispense a treat upon generation of a signal by the network communication terminal. In one embodiment, an animal treat dispenser may emit an audible signal to alert an animal to dispensation of a treat; such signal may include one or more tones or beeps, or a pre-recorded or live voice signal generated by the owner, such as may be generated with a network communication terminal. In one embodiment, an animal treat dispenser, water dispenser, or feeding apparatus may automatically sense a condition of depletion or near-depletion of animal treats, water, or food, and automatically notify an owner or third party (whether locally or via a network communication device) of such condition, to facilitate restocking of the treat dispenser, water dispenser, and/or feeding apparatus to minimize interruption in feeding or watering of the animal.

Certain embodiments are directed to devices for monitoring operation of an animal containment boundary defining apparatus, such as an apparatus including a boundary signal transmitting wire (e.g., a buried wire-type antenna), intended to detect abnormal operation and/or faults and to bring such information to the attention of the animal owner. In one embodiment, a monitoring device includes a power input element (e.g., electrical plug, terminals, contacts, or the like) connectable to one or more electric power sources (e.g., battery, AC source, etc.). The monitoring device includes at least one sensing element arranged to detect at least one (possibly more than one) of presence, absence, magnitude, and change in magnitude of at least one electrical signal in the at least one boundary signal transmitting wire. The monitoring device further includes an alarm signal generating element arranged to generate at least one primary alarm signal upon detection by the at least one sensing element of at least one of presence, absence, magnitude, and change in magnitude of at least one electrical signal in the at least one boundary signal transmitting wire. Such a monitoring device may be communicatively coupled to a communication device adapted to transmit at least one secondary alarm signal or message to a user via a telecommunication network.

The at least one sensing element of the foregoing monitoring device may include one or more of a current sensor, a voltage sensor, and an impedance or resistance sensor. In one embodiment, the at least one sensing element is inductively coupled with at least one boundary signal transmitting wire without conductive contact (e.g., as may require cutting or splicing of the boundary signal transmitting wire). In one embodiment, a monitoring device includes a signal generator adapted to transmit a test signal through the at least one boundary signal transmitting wire, wherein the at least one sensing element is adapted to detect at least one of presence, absence, magnitude, and change in magnitude of the test signal in the at least one boundary signal transmitting wire. In certain embodiments, multiple boundary signal transmitting wires may be provided, such that the monitoring device may include a first sensing element arranged to detect at least one of presence, absence, magnitude, and change in magnitude of at least one electrical signal in the first boundary signal transmitting wire, and may include a second sensing element arranged to detect at least one of presence, absence, magnitude, and change in magnitude of at least one electrical signal in the second boundary signal transmitting wire.

The foregoing monitoring device may further include one or more of the following features: (a) a radio frequency (RF) signal transmitter arranged to transmit the at least one alarm signal to a radio frequency transmit/receive (RFTR) station; (b) a RF signal receiver arranged to receive at least one RF signal from a RFTR station; and (c) a memory arranged to store signals generated by any of (i) the alarm signal generating element and (ii) the at least one sensing element.

Certain embodiments of the present invention are directed to devices and methods for affecting operation of a premises security systems (or associated motion detectors) to avoid triggering false alarms through operation of motion detectors. In certain embodiments, methods and devices generally involve sensing a condition indicative of any of (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generating an animal status output signal indicative of said sensed condition; and utilizing the animal status output signal to affect whether a motion detector output signal should be used to trigger a premises security system alarm signal. In certain embodiments, the foregoing sensing includes use of at least one stationary radio frequency receiver to detect strength of at least one radio frequency signal transmitted between the stationary radio frequency receiver and the animal collar or tag. In certain embodiments, the foregoing sensing includes use of an infrared detector arranged to interact with an infrared transmitter associated with an animal collar or tag. Certain embodiments further include communication to a user, via a communication network, of a signal indicative of triggering of a premises security system alarm signal.

In various embodiments, methods directed to avoid triggering false alarms through operation of motion detectors may be implemented in (a) a motion detector having an integrated secondary detector and signal processing element (e.g., as may be integrated into a single body structure) for comparing signals of primary and secondary detectors; (b) an auxiliary device including a secondary detector and a signal processing element, arranged to be connected between a conventional motion detector and a premises security system controller; or (c) a premises security system including a controller arranged to process signals separately received from a motion detector and a secondary detector.

In certain embodiments, a motion detector for a premises security system includes a primary signal transmitter arranged to transmit a primary wireless signal; a primary signal detector arranged to receive a reflected portion of the primary wireless signal and responsively generate a primary signal detector output signal; a secondary signal detector arranged to communicate with a mobile signal transmitter of an animal collar or tag, and arranged to sense a condition indicative of any of (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generate an animal status output signal indicative of said sensed condition; and a signal processing element arranged to utilize the primary signal detector output signal and the animal status output signal, and responsively generate a motion detector output signal. In certain embodiments, the secondary signal detector may include one or more of a RF receiver and an IR receiver or detector. In certain embodiments, a premises security system includes the foregoing motion detector. Any additional functions or elements as disclosed herein may be added to such a premises security system.

In certain embodiments, a premises security system includes a motion detector including (a) a primary signal transmitter arranged to transmit a primary wireless signal, and (b) a primary signal detector arranged to receive a reflected portion of the primary wireless signal and responsively generate a motion detector output signal; a secondary signal detector arranged to communicate with a mobile signal transmitter of an animal collar or tag, and arranged to sense a condition indicative of any of (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generate an animal status output signal indicative of said sensed condition; and a signal processing element arranged to utilize the animal status output signal in determining any of (a) whether the motion detector output signal should be transmitted to a control element of the premises security system and (b) whether the premises security system should output a premises security system alarm signal. In certain embodiments, the secondary signal detector may include one or more of a RF receiver and an IR receiver or detector. Any additional functions or elements as disclosed herein may be added to such a premises security system.

Certain embodiments are directed to an apparatus for affecting operation of a premises security system that comprises a motion detector including (a) a primary signal transmitter arranged to transmit a primary wireless signal, and (b) a primary signal detector arranged to receive a reflected portion of the primary wireless signal and responsively generate a motion detector output signal, the apparatus comprising: a secondary signal detector arranged to communicate with a mobile signal transmitter of an animal collar or tag, and arranged to sense a condition indicative of any of (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generate an animal status output signal indicative of said sensed condition; and a signal processing element arranged to utilize the animal status output signal in determining any of (A) whether the motion detector output signal should be transmitted to a control element of the premises security system and (B) whether the premises security system should output a premises security system alarm signal. In certain embodiments, the secondary signal detector may include one or more of a RF receiver and an IR receiver or detector.

Certain embodiments are directed to devices and methods for verify operation and/or detecting failure or impending failure (e.g., due to a low battery condition) of an electronic collar or tag arranged to cooperate with a boundary signal defining wire. Such devices and methods may include use of a secondary (add-on) animal tag or collar arranged to be worn by an animal simultaneously with a primary (pre-existing) animal tag or collar intended to cooperate with the boundary signal defining wire. Certain embodiments are directed to a secondary electronic animal tag or collar arranged to be worn by an animal and interoperable with (i) a primary electronic tag or collar worn by the animal and (ii) at least one radio frequency transmit/receive station remotely located relative to the animal, wherein the primary tag or collar comprises a primary battery, a warning signal generating element arranged to generate a user-perceptible or pet-perceptible warning signal, and a primary receiver arranged to receive a premises defining signal generated by a premises defining signal generating element, and wherein the secondary electronic animal tag or collar comprises: a secondary battery; at least one signal transmitter arranged to receive power from the secondary battery and to generate (a) a wireless signal arranged to be received by the primary receiver, and (b) a wireless signal arranged to be received by the at least one radio frequency transmit/receive (RFTR) station; and a warning signal receiver arranged to receive the user-perceptible or pet-perceptible warning signal; wherein the secondary electronic animal tag or collar is arranged to (a) generate a wireless signal arranged to be received by the primary receiver to trigger generation by the warning signal generating element of the user-perceptible or pet-perceptible warning signal, (b) detect at least one of presence, absence, and strength of the user-perceptible or pet-perceptible warning signal using the warning signal receiver, and (c) transmit a wireless signal to the at least one RFTR based upon at least one of presence, absence, and strength of the user-perceptible or pet- perceptible warning signal. When the secondary electronic animal tag or collar does not receive a signal from the primary electronic tag or collar, such condition may indicate failure of the primary electronic tag or collar, and the secondary electronic animal tag or collar may send a wireless signal to the RFTR station for notification (e.g., by a local alarm element and/or communication via one or more networked communication devices) of the animal owner or caregiver of such condition. When the secondary electronic animal tag or collar receives only a weak signal (or a signal below a predetermined threshold or previously received average signal level) from the primary electronic tag or collar, such condition may indicate impending battery failure, and a similar notification may be communicated to the RFTR station for forwarding to the animal owner or caregiver.

According to devices and methods for verifying operation and/or detecting failure or impending failure of an electronic collar or tag, in certain embodiments, the user-perceptible or pet-perceptible warning signal may include at least one of an auditory and a vibratory signal, and at least one warning signal receiver may be arranged to detect at least one of the auditory signal and the vibratory signal. In certain embodiments, a secondary electronic animal tag or collar may further include an alarm signaling element arranged to generate a user-perceptible alarm signal.

Certain embodiments of systems and components as described hereinabove are illustrated in the figures.

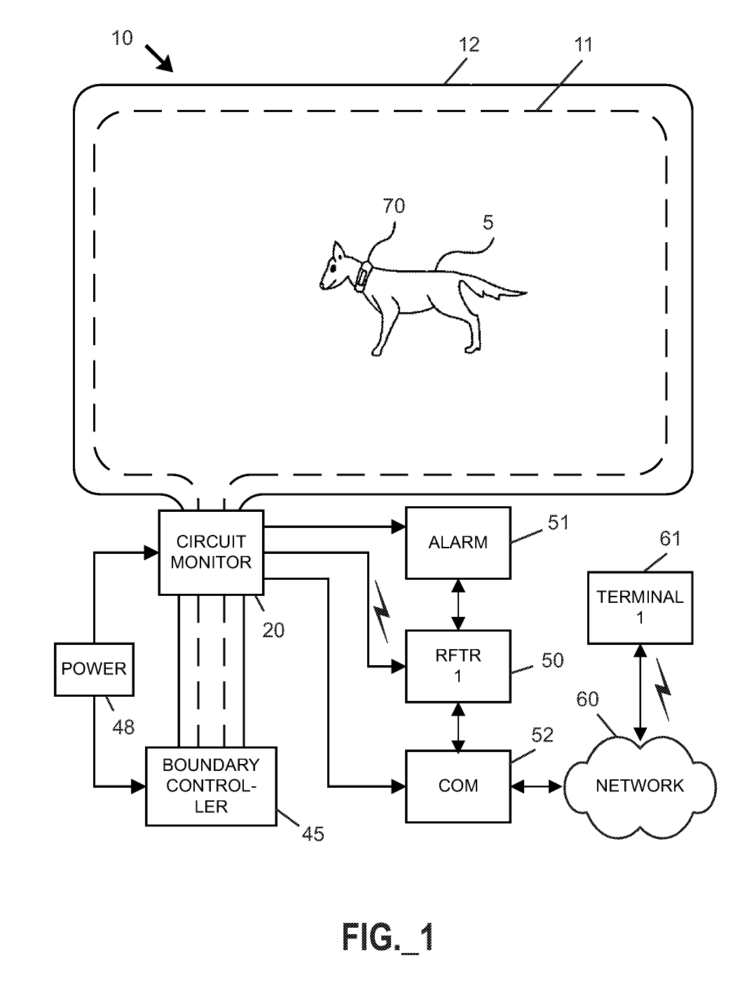

FIG. 1 is a schematic interconnect diagram showing connections between various components of a system 10 for monitoring operation of an animal containment boundary defining apparatus that includes first and second boundary signal transmitting wires 11, 12. The system 10 includes a conventional boundary controller 45 arranged to transmit and receive signals via loops formed from the wires 11, 12, which are preferably buried underground. Such wires 11, 12 form first and second boundaries around a selected area and emit signals arranged to be received by an electronic collar or tag 70 worn by an animal 5. The wires 11, 12 may be used to communicate different signals to the collar or tag 70.

For example, when the animal 5 approaches the first wire 11, the collar or tag 70 may detect a signal transmitted by the first wire 11 and responsively generate a warning signal (e.g., auditory or vibratory signal or other stimulus) to be perceived by the animal 5 as a warning that the animal 5 should not continue to approach the boundary. If the animal approaches the second wire 12, the collar or tag 70 may detect a signal transmitted by the first wire 11 and responsively generate a correction signal (e.g., an electric shock or other stimulus) to reinforce that the animal should not remain in proximity to the boundary. Such collar or tag 70 and wires 11, 12 operate in conjunction with the boundary controller 45; these elements may be conventional in nature.

To provide enhanced operation detection and notification capability, a circuit monitoring device 20 may be interposed between the boundary controller 45 and the loops formed by the wires 11, 12. The circuit monitoring device 20 preferably receives power from one or more power sources 48 (e.g., AC source and/or battery, preferably both). The circuit monitoring device 20 includes at least one sensing element arranged to detect at least one of presence, absence, magnitude, and change in magnitude of at least one electrical signal in at least one of the boundary signal transmitting wires 11, 12, and responsively generates an alarm signal (which may or may not be user-perceptible in character). Such signal may communicated to one or more of the following elements: (a) a RFTR station as described herein; (b) an alarm output element 51 arranged to generate a user-perceptible alarm signal; and (c) a network communication element 52 arranged to communicate an alarm and/or notification signal or message via a network 60 (whether wired and/or wireless in character) to at least one terminal device 61 (e.g., mobile phone, pager, computer terminal, animal shelter, etc.). In this manner, a user and/or any other relevant party may be rapidly notified of the failure and/or operational status condition (e.g., normal or fault condition) of an animal containment boundary defining apparatus. The circuit monitoring device 20 may also be used as a signal repeater to receive signals from an RFTR station or an electronic animal collar or tag, and to rebroadcast such signals to an electronic animal collar or tag or RFTR station, thereby extending communication range between the RFTR station and collar or tag.

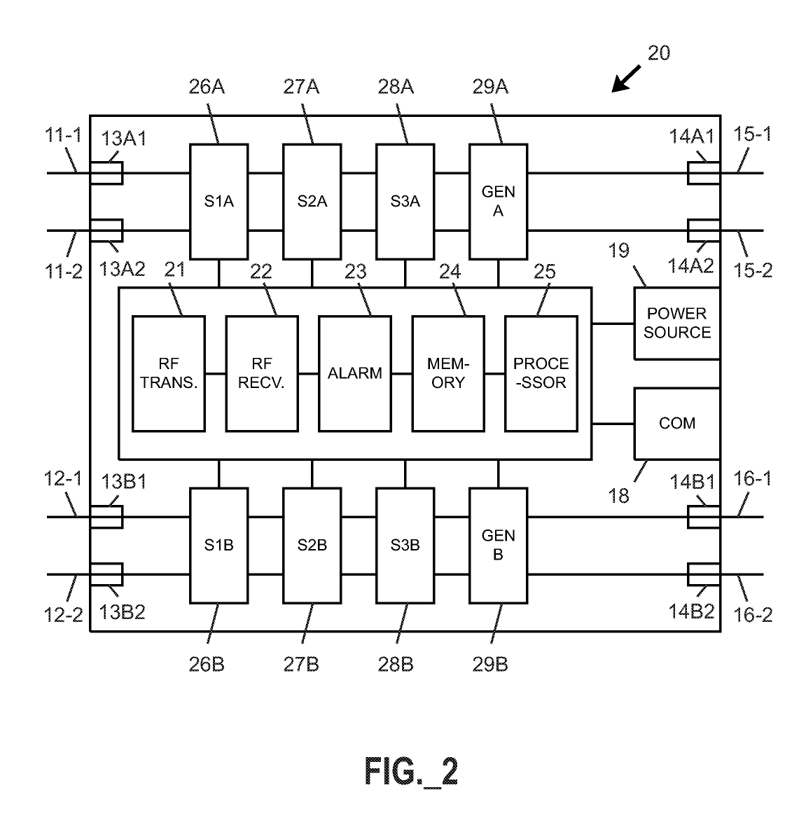

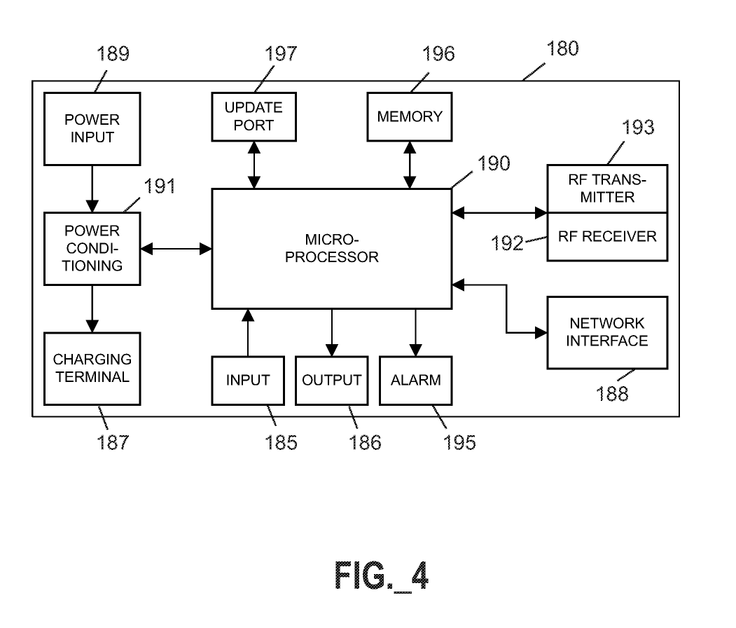

FIG. 2 is a schematic interconnect diagram showing connections between various elements of a circuit monitoring device 20 for monitoring boundary signal transmitting wires of an animal containment boundary defining apparatus. The monitoring device 20 includes a power input element 19 (e.g., battery and/or connection to AC power source), a RF transmitter 21, a RF receiver 22 (with the RF transmitter and RF receiver optionally being integrated into a RF transceiver), an alarm generating element 23, a memory element 24, a processor 25, and at least one communication port 18. The RF transmitter 21 and RF receiver 22 are preferably in two-way radio frequency communication with at least one RFTR station (as illustrated in FIG. 2 and FIG. 4). The monitoring device 20 may be arranged to receive ends 11-1, 11-2 of a primary segment of first wire, and ends 12-1, 12-2 of a primary segment second wire at terminals 13A1, 13A2, 13B1, 13B2. Additional terminals 14A1, 14A2, 14B1, 14B2 may be arranged to receive ends 15-1, 15-2 of a secondary segment of the first wire and to receive ends 16-1, 16-2 of a secondary segment of the second wire, respectively. The monitoring device 20 further includes at least one sensor 26A-28A associated with the first boundary signal transmitting wires 11-1, 11-2, and at least one sensor 26B-28B associated with the second boundary signal transmitting wires 12-1, 12-2. Test signal generators 29A, 29B may further be associated with the first boundary signal transmitting wires 11-1, 11-2 and second boundary signal transmitting wires 12-1, 12-2, respectively. The sensors 26A-28A, 26B-28B may include sensors of any type suitable for detecting presence or absence of an electrical signal and/or continuity of a circuit, including voltage sensors, current sensors, impedance sensors, resistance sensors, and the like. Although various sensors 26A-28A, 26B-28B are illustrated as spanning across respective segments of the same loop, it is to be understood that sensors according to certain embodiments are not so limited. In certain embodiments, sensors (e.g., current sensors) are inductively coupled with transmitting wires without conductive contact (e.g., as may require cutting or splicing of the boundary signal transmitting wire). When inductive sensors are used, the terminals 13A1, 13A2, 13B1, 13B2, 14A1, 14A2, 14B1, 14B1 may be eliminated. In certain embodiments, test signal generators 29A, 29B are used to transmit test signals into the wires 11-1, 11-2, 12-1, 12-2, and one or more sensors 26A-28A, 26B-28B may be used to detect presence of the test signals in one or more of the wires.

In use of the monitoring device 20, the sensors 26A-28A, 26B-28B are used to detect presence of signals in the wires 11-1, 11-2, 12-1, 12-2. Expected signals and/or historically generated signals may be stored in the memory element 24. Upon detection of a loss of signal or a departure from an expected signal in the wires 11-1, 11-2, 12-1, 12-2, various actions may be taken, such as (a) output of a user-perceptible alarm by the alarm output element 23; (b) communication of an alarm signal to an external device (e.g., RFTR station, communication network/communication device, etc.) via the communication port 18 and/or the RF transmitter 21, and (c) storage of a message or identifier of the condition in the memory element 24. By detecting and rapidly notifying an animal owner or animal caregiver of a malfunction of a boundary defining wire and/or associated boundary controller (e.g., boundary controller 45 illustrated in FIG. 1), the pet owner or caregiver can take timely action and avoid potential loss of one or more animals.

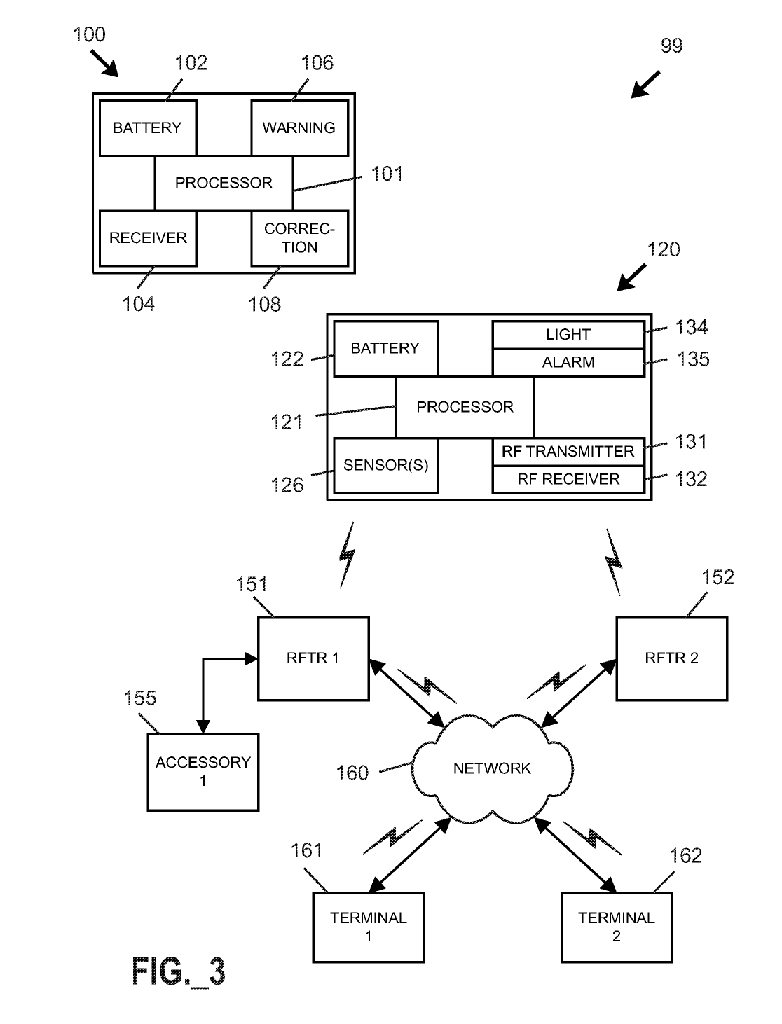

FIG. 3 is a schematic diagram depicting components of an animal containment and monitoring system 99 including a primary electronic animal tag or collar 100 arranged to interact with at least one boundary signal transmitting wire (not shown), a secondary electronic animal tag or collar 120 arranged to permit monitoring of the primary electronic animal tag or collar 100, and at least one radio frequency transmit/receive (RFTR) station 151, 152 in communication with the secondary electronic animal tag or collar 120 and other components via a communication network 160. The primary electronic animal tag or collar 100 includes a power source (e.g., battery) 102, a processor 101, a signal receiver 104 (e.g., arranged to receive a signal transmitted by a subterranean boundary defining wire), a warning signal generator 106, and a correction signal generator 108. The secondary electronic animal tag or collar 120 includes a power source (e.g., battery) 122, a processor 121, at least one RF transmitter 131 (e.g., arranged to communicate with the primary electronic animal tag or collar 100 and with one or more of the RFTR stations 151, 152) and RF receiver 132 (e.g., arranged to communicate with one or more of the RFTR stations 151, 152), one or more sensors 126 arranged to sense a signal (e.g., warning and/or correction signal) generated by the primary electronic animal tag or collar 100, a light 134, and an alarm output element 135. The RFTR stations 151, 152 are arranged in communication (e.g., via wired and/or wireless means) with a communication network 160 in communication (e.g., via wired or wireless means) with communication terminals 161, 162, such as may be embodied in mobile phones, pages, PDA, computers, etc.. One or more accessory devices 155 may be arranged in communication with one or more of the RFTR stations 151, 152.

In operation of the system 99, the secondary electronic animal tag or collar 120 is arranged to output a RF signal (via the at least one RF transmitter 131) arranged to elicit an action by the primary electronic animal tag or collar 100, with such action being detectable by the secondary electronic animal tag or collar 120 (e.g., with sensor(s) 126 and/or the RF receiver 132). In certain embodiments, the output signal may mimic interaction between a primary electronic animal tag or collar and a boundary defining wire, and the resulting action may include, for example, generation of an auditory or vibratory warning signal. Upon detection of the resulting action, the secondary electronic tag or collar 120 may verify that the primary electronic tag or collar 100 is working properly. If the secondary electronic tag or collar 120 does not detect the expected action (e.g., after one or multiple attempts), then such non-detection may indicate that the primary electronic tag or collar 100 is not working properly, and appropriate notification and/or alarm steps may be undertaken to notify the animal owner, animal caregiver, or other interested part of such status. One or more of the following steps may be initiated: (a) an alarm may be generated by the alarm output element 135 of the secondary electronic animal tag or collar 120; (b) a signal may be transmitted via the RF transmitter 131 to one or more RFTR stations 151, 152; (c) an alarm signal or message may be communicated to the terminal(s) 161, 162 via the communication network 160; and (d) an accessory device 155 may be activated or deactivated (e.g., to entice the animal to stay within the boundary by offering food, activating a toy, opening a door, or initiating any other suitable action). By detecting and rapidly notifying an animal owner or animal caregiver of a malfunction of a primary electronic animal tag or collar, the pet owner or caregiver can take timely action and avoid potential loss of one the animal.

FIG. 4 is a schematic diagram showing functional relationships between various elements of a radio frequency transmit/receive (RFTR) station 180. At least one power input terminal 189 receives power from a power source (e.g., AC outlet or battery pack). A power conditioning element 191 may provide power conditioning and/or regulating utility, including AC/DC power conversion. Although only a microprocessor 190 is shown in direct electrical communication with the power conditioning element 191, it is to be appreciated that electrical power may be conducted to any of various electrically operated elements in the RFTR station 180, whether or not through the microprocessor 190. One or more charging terminals or contacts 187 may be provided to permit recharging of an electronic pet tag upon contact with the terminal(s) or contact(s) 187. At least one input element 185 and at least one output element 186 are arranged to communicate with the microprocessor 190. An alarm generator 195 may output an audible alarm, output a visible alarm, and/or trigger a remote alarm, such as notification of one or more users, home alarm monitoring companies, animal shelters, law enforcement agencies, and third parties (e.g., via a network interface 188).

Continuing to refer to FIG. 4, a computer-readable or processor-readable instruction set (e.g., operating instructions) for execution by the microprocessor 190 may be stored on a memory element 196. Operating instructions for the RFTR station 180 may be updated via a network interface 188 or an optional update port 197 (e.g., USB port, miniature USB port, or the like). The update port 197 may further be used to read or extract information logged to the memory 196, as the memory 196 may be used to store information received from the RF receiver 192 and/or from an external network via the network interface 188. A RF transmitter 193 and a RF receiver 192 (optionally integrated within a RF transceiver) are further arranged to communicate with the microprocessor 190, and may communicate wirelessly in two-way fashion with one or more electronic pet tags as described herein. In one embodiment, the RF transmitter 193 and RF receiver 192 may simultaneously communicate with up to eight different electronic pet tags as described herein.

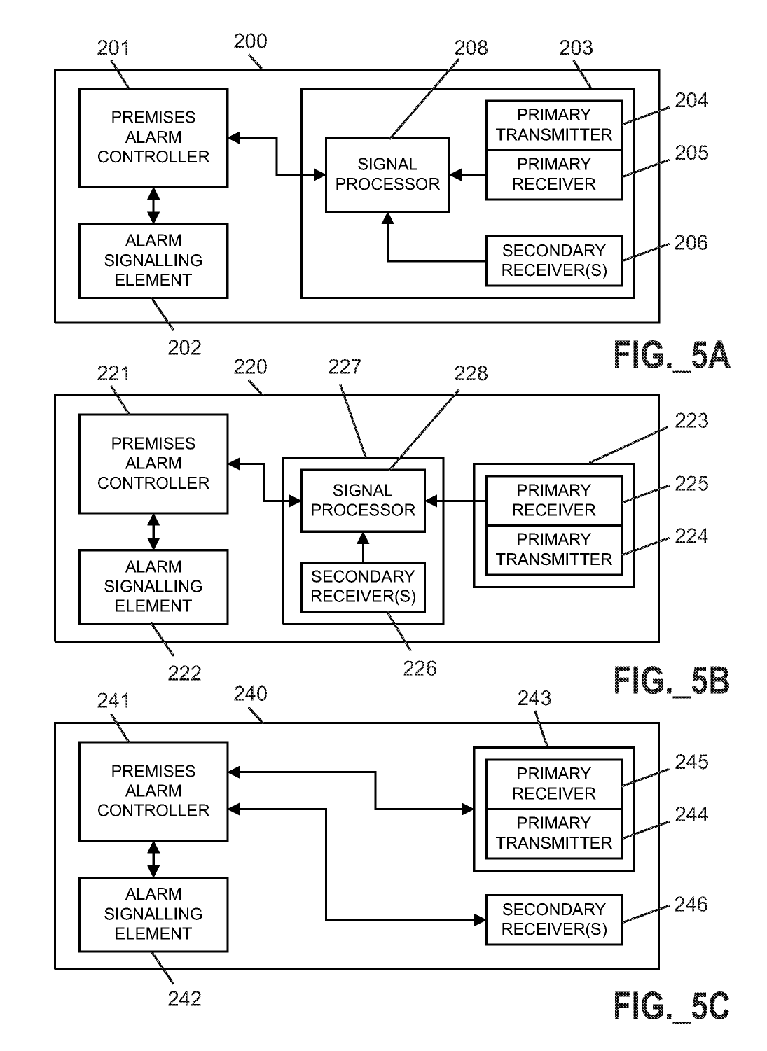

FIGS. 5A-5C illustrate devices arranged to avoid triggering false alarms through operation of motion detectors, as implemented in: (a) a motion detector having an integrated secondary detector and signal processing element (e.g., as may be integrated into a single body structure) for comparing signals of primary and secondary detectors according to FIG. 5A; (b) an auxiliary device including a secondary detector and a signal processing element, arranged to be connected between a conventional motion detector and a premises security system controller according to FIG. 5B; and (c) a premises security system including a controller arranged to process signals separately received from a motion detector and a secondary detector according to FIG. 5C. By comparing signals of a primary receiver of a motion detector and a signal of a secondary detector (e.g., RF, infrared, or the like) arranged to communication with an electronic animal collar or tag, a motion detector signal can be validated or disregarded to avoid false alarms. That is, if a primary receiver of a motion detector detects motion and generates a resulting signal, such signal may be compared or otherwise processed in conjunction with an output of a secondary signal detector or receiver arranged to detect an electronic animal tag or collar. The secondary signal detector may be arranged to sense a condition indicative of any one or more of the following: (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generate an animal status output signal indicative of said sensed condition. If a primary receiver of a motion detector detects movement, and if the animal status output signal (e.g., upon comparison or processing thereof) indicates that the movement is not likely to have been caused by the animal, then a premises security system may triggered to output a premises security alarm signal. Otherwise, if motion is detected by a primary receiver of a motion detector, but such motion is indicated by the secondary receiver to correspond to movement of the animal tag or collar, then a premises security system may not be triggered to output a premises security alarm signal.

FIG. 5A is a schematic interconnect diagram of various components of a premises alarm system 200 including a motion detector 203 having a primary transmitter 204, a primary receiver 205, and a secondary receiver 206 arranged to communicate with an electronic animal collar or tag, with the motion detector 203 further including a signal processor 208 arranged to receive signals from the primary and secondary receivers 205, 206. The motion detector 203 may include a body structure including the foregoing elements. A single output of the motion detector 203 is supplied to a premises alarm controller 201 coupled to a premises alarm signaling element 202.

FIG. 5B is a schematic interconnect diagram of various components of a premises alarm system 220 including (i) a motion detector 223 having a primary transmitter 224 and a primary receiver 225, and (ii) a verification device 227 including a signal processor 228 and a secondary receiver 226 arranged to communicate with an electronic animal collar or tag and a signal processor, with the signal processor 228 being arranged to receive signals from the primary and secondary receivers 225, 226. A single output of the verification device 227 is supplied to a premises alarm controller 221 coupled to a premises alarm signaling element 222. One advantage of providing a signal processor 228 and secondary receiver 226 in a verification device 227 is that such verification device 227 may be easily interposed between an existing premises alarm controller and a conventional motion detector without requiring modification of either device.

FIG. 5C is a is a schematic interconnect diagram of various components of a premises alarm system 240 including (i) a motion detector 243 having a primary transmitter 244 and a primary receiver 245, and (ii) a secondary receiver 246 arranged to communicate with an electronic animal collar or tag, wherein signals from the motion detector 243 and the secondary receiver 246 are provided to a premises alarm controller 241 and a premises alarm signaling element 242. In this embodiment, processing of output signals of the motion detector 243 and the secondary receiver 246 is performed by the alarm controller 241.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Any of various elements or features recited herein are contemplated for use in combination with other features or elements disclosed herein, unless specified to the contrary. Correspondingly, the invention as hereinafter claimed is intended to be broadly construed and interpreted, as including all such variations, modifications and alternative embodiments, within its spirit and scope.

What is claimed is:

1. A device for monitoring operation of an animal containment boundary defining apparatus that includes at least one boundary signal transmitting wire, the device comprising:
a power input element connectable to an electric power source;
at least one sensing element arranged to detect at least one of presence, absence, magnitude, and change in magnitude of at least one electrical signal in the at least one boundary signal transmitting wire; and
an alarm signal generating element arranged to generate at least one primary alarm signal upon detection by the at least one sensing element of at least one of presence, absence, magnitude, and change in magnitude of at least one electrical signal in the at least one boundary signal transmitting wire.

2. The device according to claim 1, further comprising a radio frequency (RF) signal transmitter arranged to transmit the at least one alarm signal to a radio frequency transmit/receive (RFTR) station.

3. The device according to claim 1, further comprising a memory arranged to store signals generated by any of (i) the alarm signal generating element and (ii) the at least one sensing element.

4. The device according to claim 1, further comprising at least one radio frequency (RF) signal transmitter and at least one radio frequency (RF) signal receiver, wherein the at least one RF signal transmitter and the at least one RF signal receiver are adapted to communicate wirelessly with an animal collar or tag that includes a mobile RF transmitter and a mobile RF receiver.

5. The device according to claim 1, further comprising at least one radio frequency (RF) signal transmitter and at least one radio frequency (RF) signal receiver, wherein the at least one RF signal transmitter and the at least one RF signal receiver are adapted to communicate wirelessly with an animal collar or tag that includes a mobile RF transmitter and a mobile RF receiver, and wherein the at least one RF signal transmitter and the at least one RF signal receiver are adapted to communicate wirelessly with a radio frequency transmit/receive (RFTR) station.

6. The device according to claim 1, wherein the at least one sensing element comprises any of a current sensor and a voltage sensor.

7. The device according to claim 1, wherein the at least one sensing element is inductively coupled with the at least one boundary signal transmitting wire.

8. The device according to claim 1, wherein:
the at least one boundary signal transmitting wire comprises first and second boundary signal transmitting wires;
the at least one sensing element comprises a first sensing element arranged to detect at least one of presence, absence, magnitude, and change in magnitude of at least one electrical signal in the first boundary signal transmitting wire; and
the at least one sensing element comprises a second sensing element arranged to detect at least one of presence, absence, magnitude, and change in magnitude of at least one electrical signal in the second boundary signal transmitting wire.

9. The device according to claim 1, further comprising a signal generator adapted to transmit a test signal through the at least one boundary signal transmitting wire, wherein the at least one sensing element is adapted to detect at least one of presence, absence, magnitude, and change in magnitude of the test signal in the at least one boundary signal transmitting wire.

10. The device according to claim 1, wherein the at least one primary alarm signal comprises a user-perceptible alarm signal.

11. The device according to claim 1, communicatively coupled to a communication device adapted to transmit at least one secondary alarm signal or message to a user via a telecommunication network.

12. A motion detector for a premises security system, the motion detector comprising:
a primary signal transmitter arranged to transmit a primary wireless signal;
a primary signal detector arranged to receive a reflected portion of the primary wireless signal and responsively generate a primary signal detector output signal;
a secondary signal detector arranged to communicate with a mobile signal transmitter of an animal collar or tag, and arranged to sense a condition indicative of any of (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generate an animal status output signal indicative of said sensed condition; and
a signal processing element arranged to utilize the primary signal detector output signal and the animal status output signal, and responsively generate a motion detector output signal.

13. The motion detector according to claim 12, wherein the secondary signal detector comprises a radio frequency receiver.

14. The motion detector according to claim 12, wherein the secondary signal detector comprises an infrared receiver.

15. The premises security system comprising a motion detector according to claim 12.

16. The premises security system comprising:
a motion detector including (a) a primary signal transmitter arranged to transmit a primary wireless signal, and (b) a primary signal detector arranged to receive a reflected portion of the primary wireless signal and responsively generate a motion detector output signal;
a secondary signal detector arranged to communicate with a mobile signal transmitter of an animal collar or tag, and arranged to sense a condition indicative of any of (i) presence of the animal collar or tag proximate to the motion detector, (ii) absence of the animal collar or tag proximate to the motion detector, (iii) proximity of the animal collar or tag relative to the motion detector, (iv) stasis of the animal collar or tag, and (v) movement of the animal collar or tag, and responsively generate an animal status output signal indicative of said sensed condition; and
a signal processing element arranged to utilize the animal status output signal in determining any of (a) whether the motion detector output signal should be transmitted to a control element of the premises security system and (b) whether the premises security system should output a premises security system alarm signal.

17. The premises security system according to claim 16, wherein the secondary signal detector comprises a radio frequency receiver.

18. The premises security system according to claim 16, wherein the secondary signal detector comprises an infrared receiver.

19. The premises security system according to claim 16, wherein the secondary signal detector and the signal processing element are integrated into a single body structure.

20. The premises security system according to claim 16, communicatively coupled to a communication device adapted to transmit at least one alarm signal or message to a user via a telecommunication network.
